(19) United States
(12) Patent Application Publication
(10) Pub. No.: US 2002/0191206 A1
(43) Pub. Date: Dec. 19, 2002

(54) Rendering broker service and method

(76) Inventors: Jeff M. Anderson, Camas, WA (US); Sherri L. Brown, Clackamas, WA (US); Jeremy Bunn, Kelso, WA (US); David M. Hall, Camas, WA (US); David J. Miller, Camas, WA (US); Karen E. Misustin, West Linn, OR (US); Lainye Reich, Vancouver, WA (US); Daniel Revel, Portland, OR (US); David Staas, Camas, WA (US)

Correspondence Address: HEWLETT-PACKARD COMPANY, Intellectual Property Administration, P.O. Box 272400, Fort Collins, CO, 80527-2400, US

(21) Appl. No.: 09/884,593

(22) Filed: Jun. 18, 2001

(51) Int. Cl. G06F 15/00; B41B 1/00

(52) U.S. Cl. 358/1.13

(57) ABSTRACT

A system and method are provided for brokered rendering. In one embodiment, the method comprises the steps of: examining a document embodied in a non-rendered format in a computer system to identify at least one rendering operation to be performed to convert the document into a rendered format to be employed in printing the document, identifying at least one rendering application capable of performing the at least one rendering operation, and, applying the document to the at least one rendering application to implement the at least one rendering operation.

### TECHNICAL FIELD

The present invention is generally related to the field of printing and, more particularly, is related to a system and method for mobile printing

### BACKGROUND OF THE INVENTION

Recent years have seen a proliferation of portable electronic devices such as personal digital assistants (PDA's), cellular telephones, and/or other portable electronic devices. For example, personal digital assistants are now available such as the HP Jornada manufactured by Hewlett-Packard Company based in Palo Alto, Calif., or the Blackberry™ manufactured by Research in Motion™ Limited based in Ontario, Canada as well as other brands. These mobile devices offer a range of capabilities, including mobile calendars, organizing capabilities, and electronic mail (email) received and transmitted via a mobile pager network or other mobile networks, etc.

Unfortunately, these devices are typically limited in their capabilities due to the fact that they are limited in their processing capacity and memory size. For example, many such devices cannot execute the many different applications that are available for the average personal computer. Specifically, such devices may not be able to implement word processors or other extensive applications.

When it comes to activities such as printing, etc., such devices typically are unable to perform various tasks such as rendering documents in printer compatible form, etc. This fact can negatively impact the usefulness of such devices. For example, a user may find themselves in the situation where they are standing in front of a printer with their personal digital assistant in hand and a document stored thereon that they wish to print. Unfortunately, in such a circumstance, the user may be prevented from printing a document with the printer due to the limited capability of the personal digital assistant and the lack of connectivity between the printer and the personal digital assistant.

In yet another situation, a user may have a laptop computer that has the computing capacity to perform the tasks necessary to print a document. However, the user may be in a location where they do not have access to their usual printer. In such a case, the user may be prevented from printing to any available printer because it is a different model that requires a rendering application such as a required printer driver that is not stored on their laptop. Also, in some cases the user may wish to print a document that was created using an application that the user does not have on the laptop. The user may be prevented from printing such a document as the missing application may be necessary to render the document for printing.

### SUMMARY OF THE INVENTION

In view of the forgoing, a system and method are provided for brokered rendering. In one embodiment, a method for brokered rendering is provided that comprises the steps of: examining a document embodied in a non-rendered format in a computer system to identify at least one rendering operation to be performed to convert the document into a rendered format to be employed in printing the document, identifying at least one rendering application capable of performing the at least one rendering operation, and, applying the document to the at least one rendering application to implement the at least one rendering operation.

In another embodiment, the present invention provides for a system for brokered rendering. In this regard, the present system comprises a processor circuit having a processor and a memory. Stored on the memory and executable by the processor is a rendering broker. The rendering broker comprises logic that examines a document embodied in a non-rendered format to identify at least one rendering operation to be performed to convert the document into a rendered format to be employed in printing the document, logic that identifies at least one rendering application capable of performing the at least one rendering operation, and, logic that applies the document to the at least one rendering application to implement the at least one rendering operation.

In yet another embodiment, the present invention provides for a program embodied in a computer readable medium for brokered rendering. In this respect, the program comprises code that examines a document embodied in a non-rendered format to identify at least one rendering operation to be performed to convert the document into a rendered format to be employed in printing the document, code that identifies at least one rendering application capable of performing the at least one rendering operation, and, code that applies the document to the at least one rendering application to implement the at least one rendering operation.

Other features and advantages of the present invention will become apparent to a person with ordinary skill in the art in view of the following drawings and detailed description. It is intended that all such additional features and advantages be included herein within the scope of the present invention.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 depicts a block diagram that depicts a distributed rendering network that employs a rendering broker that provides for remote rendering according to an aspect of the present invention;

FIG. 2A is a block diagram of a first print client in the network of FIG. 1;

FIG. 2B is a block diagram of a second print client in the network of FIG. 1;

FIG. 3 is a flow chart of a rendering control system executed in the first and second print clients of FIGS. 1 and 2; and

FIG. 4 is a flow chart of the rendering broker of FIG. 1.

### DETAILED DESCRIPTION OF THE INVENTION

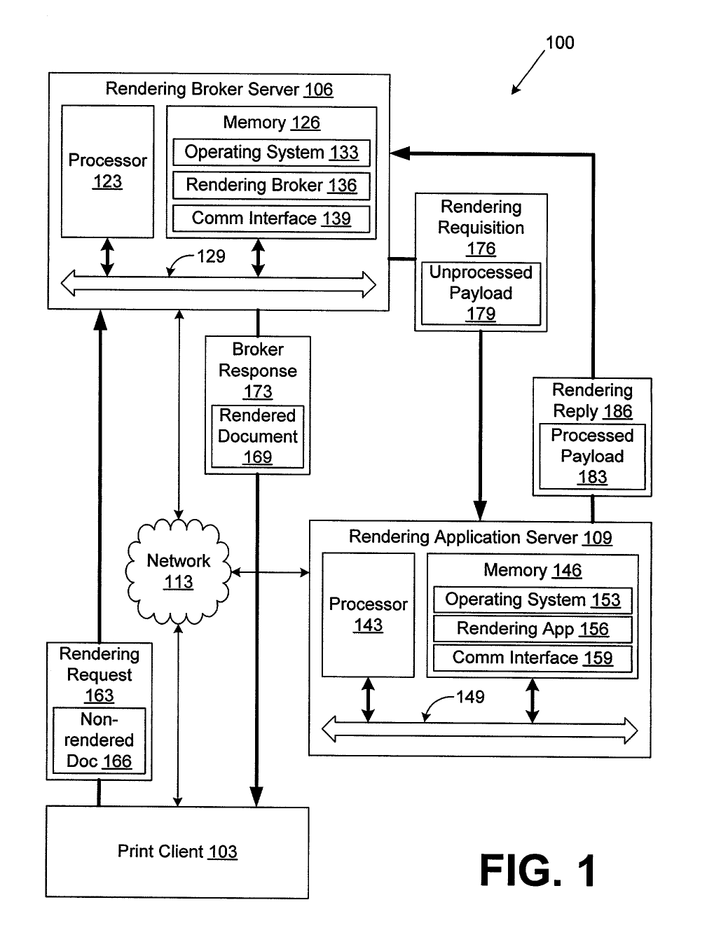

With reference to FIG. 1, shown is a distributed rendering network 100 according to an aspect of the present invention. The distributed rendering network 100 includes a number of components as will be described. To facilitate the discussion of the present invention, first the physical makeup of the distributed rendering network 100 is described. Thereafter, the operation of the distributed rendering network 100 is discussed.

The distributed rendering network 100 includes a print client 103, a rendering broker server 106, and a rendering application server 109, all of which are coupled to a network 113. In this respect, the print client 103, rendering broker server 106, and the rendering application server 109 may each comprise a computer system or other similar device or system. Alternatively, the print client 103 may comprise, for example, a network compatible printer as will be described. The network 113 includes, for example, the Internet, wide area networks (WANs), local area networks, or other suitable networks, etc., or any combination of two or more such networks.

The rendering broker server 106 includes a processor circuit with a processor 123 and a memory 126, both of which are coupled to a local interface 129. In this respect, the rendering broker server 106 may comprise a computer system or other system with like capability. The local interface 129 may comprise, for example, a data bus with an accompanying control/address bus as is generally understood by those with ordinary skill in the art. Stored on the memory 126 and executable by the processor 123 are an operating system 133, a rendering broker 136, and a communications interface 139. Other components and systems may be stored on the memory 126 and executable by the processor 123 as well. The specific functionality of the operating system 133, the rendering broker 136, and the communications interface 139 will be discussed later.

The rendering application server 109 also includes a processor circuit with a processor 143 and memory 146, both of which are coupled to a local interface 149. In this respect, the rendering application server 109 may comprise a computer system or other system with like capability. The local interface 149 may comprise, for example, a data bus with an accompanying control/address bus as is generally known by those with ordinary skill in the art. The rendering application server 109 also includes an operating system 153, a rendering application 156, and the communications interface 159 that are stored on the memory 146 and are executable by the processor 143. The specific operation of the operating system 153, the rendering application 156, and the communications interface 159 is to be described in text that follows.

Also, various peripheral devices may be employed with the rendering broker server 106, the rendering application server 109, and the print client 103 such as, for example, a keypad, touch pad, touch screen, microphone, scanner, mouse, joystick, or one or more push buttons, etc. The peripheral devices may also include display devices, indicator lights, speakers, printers, etc. Specific display devices may be, for example, cathode ray tubes (CRT), liquid crystal display screens, gas plasma-based flat panel displays, or other types of display devices, etc.

Next, an overview of the operation of the distributed rendering network 100 is provided. The print client 103, rendering broker server 106, and the rendering application server 109 communicate with each other through the network 113 in accomplishing the various tasks as described with reference to the present invention. In this respect, the print client 103 may generate a rendering request 163 that includes a non-rendered document 166 according to an aspect of the present invention. The rendering broker 136 receives the rendering request 163 and provides for the rendering of the non-rendered document 166, thereby creating the rendered document 169. The rendered document 169 is included in a broker response 173 that is generated by the rendering broker 136 and transmitted to the print client 103. The rendered document 169 is thus in a format that is compatible with the print client 103 for printing as will be discussed.

In rendering the non-rendered document 166, the rendering broker 136 interfaces with one or more rendering applications 156 on one or more rendering application servers 109. In particular, the rendering broker 136 generates a rendering requisition 176 for each rendering operation to be performed and includes an unprocessed payload 179 that may be, for example, the non-rendered document 166 or other document embodied in an intermediate print format or other format as will be described. The document that is ultimately included as the unprocessed payload 179 is one that is to be subjected to a rendering operation. The rendering requisition 176 is transmitted to the rendering application server 109 and applied to the rendering application 156. The rendering application 156 converts the document that is the unprocessed payload 179 into a processed payload 183 that is included in a rendering reply 186. The rendering reply 186 is then transmitted back to the rendering broker 136. In this manner, the rendering broker 136 requisitions various rendering applications 156 to perform various rendering operations that are necessary to convert the non-rendered document 166 into the rendered document 169.

Before a more detailed description of the operation of the rendering broker 136 is provided, an overview of the general printing process is provided to lend context to the discussion of the present invention. In particular, a typical application that is used to generate a document in digital form may be manipulated by a user to print the document on paper using one of many available printers. Such applications may include, for example, Microsoft Word that is created by Microsoft Corporation of Redmond, Washington, Adobe Acrobat created by Adobe Systems Incorporated of San Jose, Calif., and other such applications. When such applications are used to print a digital document, the applications typically render the document through an appropriate operating system or other system into a generic document construct that acts as an intermediate print format of the document.

Such intermediate print formats may comprise, for example, an Enhanced Meta File (EMF) format or a Hewlett Packard Page Description Language (HPPDL) or other intermediate print format. Thereafter, a document that is embodied in the intermediate print format is then further rendered into a printer ready format that may comprise, for example, a printer control language (PCL) or other language that is native to the printer upon which the user wishes to print the document. The transformation from the intermediate print format into printer ready format may typically be performed, for example, by a printer driver or other similar device.

It should be readily apparent to one skilled in the art that the rendering of a non-rendered document generated by a typical application into a printer ready format accepted by a printer might involve one or more predefined rendering operations. Specifically, one rendering operation may be to transform a digital document embodied in the non-rendered format that is native to the application into the intermediate print format. A second rendering operation would then be implemented to transform a document embodied in the intermediate print format into the printer ready format.

In many cases, a particular print client 103 may not include the application that is needed to perform the rendering operation in order to convert a digital document into the intermediate print format. Likewise, the print client 103 may lack the ability to render a particular document embodied in the intermediate print format into the printer ready format. In either case, the print client 103 generates a rendering request 163 and transmits the same to the rendering broker server 106 in order that the rendering broker 136 can broker the performance of one or more rendering operations to generate the rendered document 169 that is ultimately transmitted back to the print client 103. In this respect, the non-rendered document 166 would be the digital document in the format that could not be further rendered by the print client 103 either because it lacks the application or printer driver to do so or lacks the processing power to execute the necessary application or printer driver.

For example, in one scenario the print client 103 may include the printer driver necessary to perform the conversion from the intermediate print format to the printer ready format, however the same print client 103 lacks the application to convert the document in the application native format into the intermediate print format. In such case, the non-rendered document 166 would include the document in the application native format. The rendering request 163 would include the specification that the document be rendered into the intermediate print format for printing. Upon receiving the rendering request 163, the rendering broker 136 then brokers the performance of the needed rendering operation and obtains the digital document embodied in the intermediate print format. The rendering broker 136 then generates the broker response 173 and attaches the digital document embodied in the intermediate print format as the rendered document 169 and transmits the same to the print client 103.

In another scenario, the print client 103 may lack both the application to initially render a particular document into the intermediate print format as well as the rendering application 156 such as a printer driver to render the document into the printer ready format. In such case, the print client 103 generates the rendering request 163 that specifies that the non-rendered document 166 is to be rendered into the printer ready format. The print client 103 also associates a particular printer model with the rendering request 163 to indicate to the rendering broker 136 precisely which printer ready format is to be employed so as to be compatible with the ultimate printer on which the document is to be printed. Thus, the non-rendered document 166 is the digital document embodied in the native language of the application.

The print client 103 then transmits such a rendering request 163 to the rendering broker 136 that examines the rendering request 163 and the non-rendered document 166 to determine the precise rendering operations that are to be performed. The rendering broker 136 examines the non-rendered document 166 to determine the native format. Specifically, the language of the non-rendered document 166 is examined to determine the specific application that was employed to generate the non-rendered document 166. The rendering broker 136 then generates the rendering requisition 176 that includes the non-rendered document 166 as the unprocessed payload 179 and transmits the same to a rendering application 156 that may be, for example, the application used to generate the document in its native format.

Upon receiving the rendering requisition 176, the rendering application 156 performs the desired rendering operation and generates the rendering reply 186 with the document in the desired intermediate print format as the processed payload 183. The rendering application 156 then transmits the same back to the rendering broker 136. Since the original rendering request 163 received from the print client 103 requested the rendering of the digital document in printer ready format, the rendering broker 136 then determines an additional rendering operation to be performed to convert the document embodied in the intermediate print format into the printer ready format. The precise additional rendering operation to be performed may be determined by the fact that the rendering request 163 included the ultimate printer on which the document is to be printed, thus providing the desired printer ready format native to the printer.

The rendering broker 136 proceeds to generate a second rendering requisition 176 and attaches the document embodied in the intermediate print format as the unprocessed payload 179, transmitting the same to a second rendering application 156. The second rendering application 156 performs the operations of the printer driver, for example, in converting the intermediate print format of the document into the printer ready format. This second rendering application 156 then renders the document in the printer ready format and generates the rendering reply 186 attaching the document embodied in the printer ready format thereto as the processed payload 183. The rendering reply 186 is then transmitted back to the rendering broker 136. Upon receiving the rendering reply 186, the rendering broker 136 then creates the broker response 173 and attaches the document embodied in the printer ready format thereto as the rendered document 169. The broker response 173 is then transmitted back to the print client 103 where the print client 103 can then apply the document to the printer for printing.

In yet another scenario, the print client 103 may include the application to render the document in the intermediate print format, but it may not include the printer driver necessary to render the digital document from the intermediate print format into the printer ready format for printing. If such is the case, then the print client 103 would generate the rendering request 163 and attach the digital document embodied in the intermediate print format thereto as the non-rendered document 166 with instructions that the rendering broker 136 render the document into the printer ready format for the specified printer. Ultimately, the printer broker then responds with a broker response 173 that includes the rendered document 169 which is the document embodied in the printer ready format.

Thus it is seen that the non-rendered document 166 may be the document in any particular format that requires a rendering operation that the print client 103 cannot perform. In this respect, the rendered document 169 is a document in any format that results based upon the rendering request 163. Ultimately, the rendered document 169 is in a format that is compatible with the print client 103 for printing.

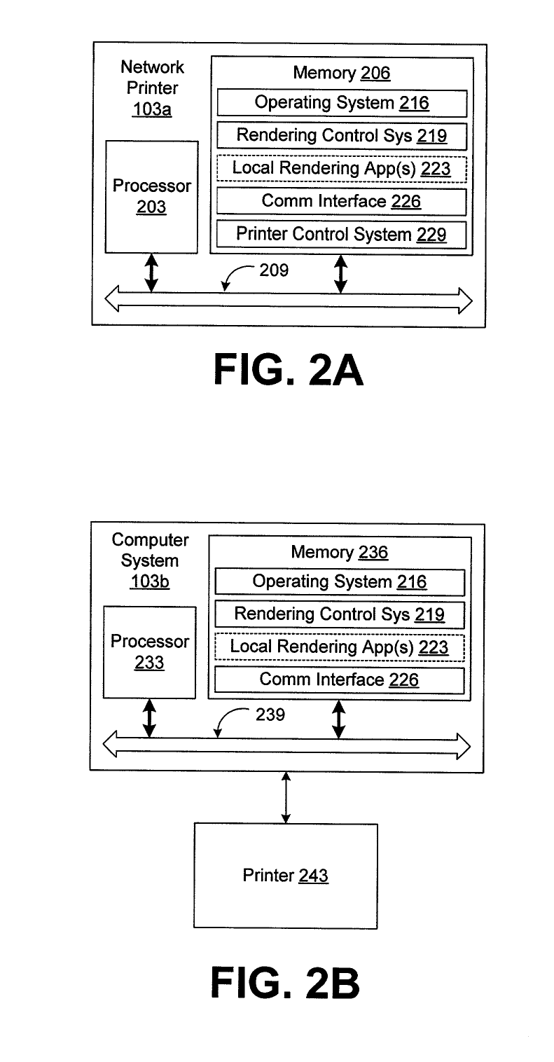

With reference to FIG. 2A, shown is a first embodiment of the print client 103 that actually comprises a network printer 103a according to an aspect of the present invention. The network printer 103a includes a processor circuit having a processor 203 and a memory 206, both of which are coupled to a local interface 209. The local interface may be, for example, a data bus with an accompanying control/address bus as is generally known by those with ordinary skill in the art. The network printer 103a also includes various software components stored on the memory 206 and executable by the processor 203. Among these are an operating system 213, a rendering control system 219, any local rendering applications 223, a communications interface 226, and a printer control system 229. Other software components may also be stored on the memory 206 and executable by the processor 203 as are generally known by those with ordinary skill in the art. In addition, the network printer 103a includes other hardware and control components to perform various print functions as is generally known by those with ordinary skill in the art and not discussed in detail herein.

The rendering control system 219 is executed in the network printer 103 to interface with the rendering broker 136 (FIG. 1) of the rendering broker server 106 providing for all necessary communications protocols, etc., that are employed by the network 113. The communications interface 226 likewise is employed to provide for the communications across the network 113 with the communications interface 139 (FIG. 1) that is executed in the rendering broker server 106. In this respect, the communications interface 226 may be, for example, the Simple Object Access Protocol (SOAP), Hypertext Transfer Protocol, or other communications interface that facilitates communication between the print client 103 and the rendering broker server 106.

The local rendering applications 223 may or may not exist on the network printer 103a depending on its local rendering capability. Specifically, the local rendering applications 223 may comprise various applications to convert a document from an application native format into the intermediate print format. The local rendering applications 223 may also entail printer drivers that convert a document from the intermediate print format into the printer ready format that is native to the network printer 103a. The absence of any local rendering applications 223 makes it necessary for the network printer 103a to seek assistance from the rendering broker server 106 to render various documents that are not in a format compatible with the functions, for example, of the network printer 103a.

With reference to FIG. 2B, shown is a second embodiment of the print client 103 that comprises a computer system 103b. In this respect, the computer system 103b includes a processor circuit with a processor 233 and a memory 236, both of which are coupled to a local interface 239. The local interface 239 may comprise, for example, a data bus with an accompanying control/address bus as is generally known by those with ordinary skill in the art. In this respect, the computer system 103b may be, for example, a personal computer or other device with like capability.

A printer 243 is coupled to the computer system 103b that is employed to print documents as is generally known by those with ordinary skill in the art. In this respect, the computer system 103b also includes an operating system 216, a rendering control system 219, local rendering applications 223, and a communications interface 226. The computer system 103b provides a second example of the print client 103 that would communicate with the rendering broker service 106 to obtain rendering services therefrom as was described previously and therefore contained similar components to those described in the network printer 103a (FIG. 2A). In addition, other embodiments of the print client 103 may be employed beyond those discussed with reference to FIGS. 2A and 2B.

In addition, each of the memories 126 (FIG. 1), 146 (FIG. 1), 206 (FIG. 2A), and 236 may include both volatile and nonvolatile memory components. Volatile components are those that do not retain data values upon loss of power. Nonvolatile components are those that retain data upon a loss of power. Thus, each of the memories 126, 146, 206, and 236 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other such of memory device.

Also, each of the processors 123 (FIG. 1), 143 (FIG. 1), 203 (FIG. 2A) and 233 may represent multiple processors and each of the memories 126, 146, 206, and 236 may represent multiple memories that operate in parallel processing circuits, respectively. In such a case, each of the local interfaces 129 (FIG. 1), 149 (FIG. 1), 209 (FIG. 2A) and 243 may be an appropriate network that facilitates communication between any two of the multiple processors, between any processor and any of the memories, or between any two of the memories, etc. The processors 123 (FIG. 1), 143 (FIG. 1), 203 (FIG. 2A) and 233 may be, for example, electrical or optical in nature.

Additionally, the operating systems 133 (FIG. 1), 153 (FIG. 1), and 216 (FIG. 2A and 2B) are each executed to control the allocation and usage of hardware resources in the rendering broker server 106, rendering application server 109, and the print clients 103a and 103b. Specifically, the operating systems 133, 153, and 216 control the allocation and usage of the memories 126,146, 206, and 236 processing time, and the peripheral devices as well as performing other functionality. In this manner, the operating systems 133, 153, and 216 serve as the foundation on which applications depend as is generally known by those with ordinary skill in the art.

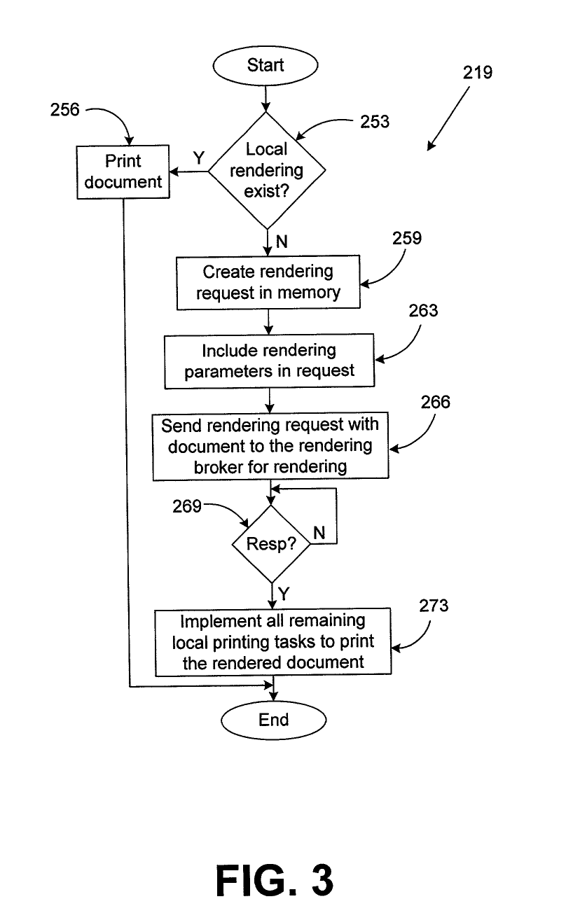

With reference to FIG. 3, shown is a flowchart of the rendering control system 219 according to an aspect of the present invention. Alternatively, the flow chart of FIG. 3 may be viewed as depicting steps in a method implemented in the print client 103 according to another aspect of the present invention. The rendering control system 219 is implemented in the print client 103 in order to determine whether the services offered by rendering broker 136 (FIG. 1) are needed to render a particular document for printing as well as to provide for the ability of the print client 103 to communicate with the rendering broker server 106.

Beginning with box 253, it is assumed that an individual has caused a digital document to be printed either on the print client 103 in the case that the print client 103 is the network printer 103A (FIG. 2A) or that the digital document is to be printed on the printer 243 (FIG. 2B) that is attached to the computer system 103b (FIG. 2B). In box 253, the rendering control system 219 determines whether the needed local rendering applications 223 (FIG. 2A and 2B) exist in the print client 103 to fully render the digital document for printing. If such is the case, then the rendering control system 219 proceeds to box 256 in which the document is rendered and printed accordingly.

On the other hand, assuming that the rendering control system 219 does not have the needed local rendering applications 223 to fully render a document for printing, then the rendering control system 219 proceeds to box 259 in which a rendering request 163 is created in the memory 206 (FIG. 2A) or 236 (FIG. 2B) of the print client 103 (FIG. 1). Thereafter, in box 263 the various rendering parameters that are necessary to effect the rendering of the document into the needed format by the print client 103 are included with the rendering request 163. The rendering control system 219 does this so that the rendering broker 136 has the needed information to identify and broker the proper rendering operations that are to be performed to generate the rendered document 169 (FIG. 1) for the print client 103. In this respect, the rendering parameters may include, for example, the desired rendering output that the print client 103 needs in order to be able to print the document.

This may be, for example, the specific intermediate print format or printer ready format into which the document is to be embodied that is compatible with the print client 103. For example, if the document is to be embodied in the intermediate print format, then the specific type of intermediate print format may be specified, such as, EMF, HPPDL, or other format, etc. If the desired rendering output is to be a printer ready format, the specific printer model may be specified or, alternatively, the specific printer control language into which the document is to be rendered is provided unless default printers or printer control languages known to be assumed by the rendering broker 136 are acceptable to the print client 103.

Where possible or necessary, the rendering control system 219 may also include information relative to the digital document itself such as, for example, the particular application that was used to create the document. For instance, the application may be Adobe Acrobat and the rendering control system 219 may include a statement in the rendering request 163 to the effect that the document is in portable document format as determined by the .pdf extension on the filename of the document. However, it may be possible that the print client 103 lacks any information about the document itself and such information thus may not be included in the rendering request 163. In such case, the rendering broker 136 (FIG. 1) will have to determine the application used to create the document.

After box 263, the rendering control system 219 proceeds to box 266 in which the rendering request 163 is transmitted to the rendering broker 136 for rendering. Thereafter, in box 269 the rendering control system 219 waits to receive a broker response 173 (FIG. 1) with the rendered document 169 (FIG. 1). Assuming that the broker response 173 has been received in box 269, then the rendering control system 219 proceeds to box 273 to implement all remaining local print tasks to print the rendered document 169. Thereafter, the rendering control system 219 ends.

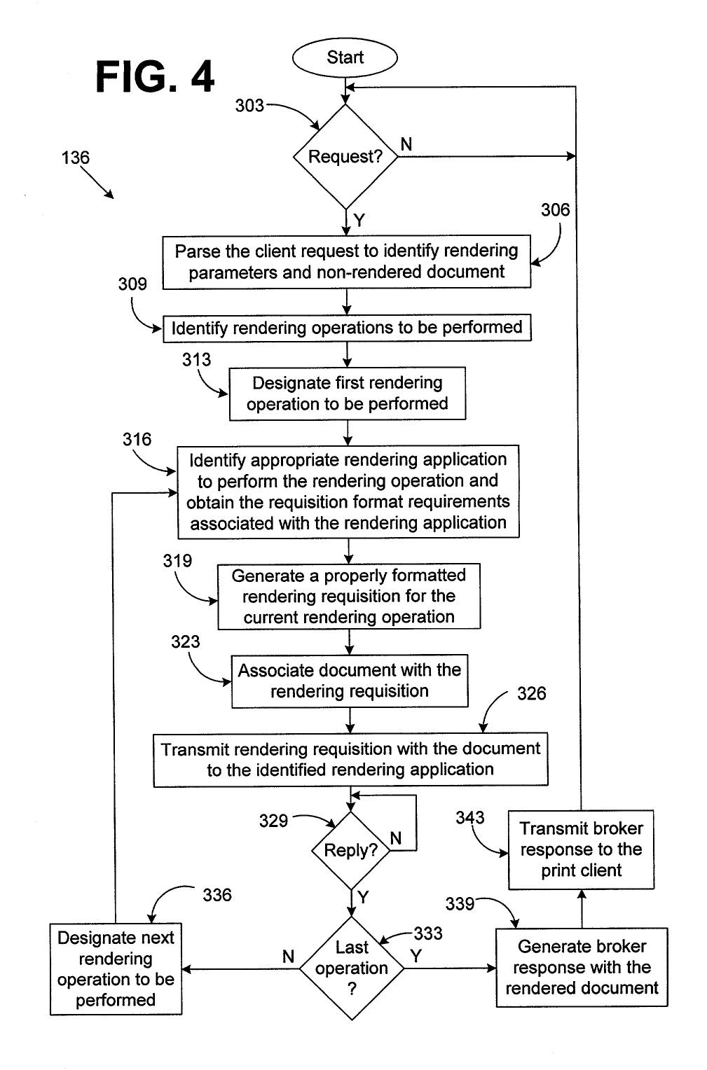

Turning then, to FIG. 4, shown is flow chart of the rendering broker 136 according to an aspect of the present invention. Alternatively, the flow chart of FIG. 4 may be viewed as depicting steps in a method implemented in the rendering broker server 106 according to an aspect of the present invention. The rendering broker 136 is executed in order to broker the rendering of the non-rendered document 166 (FIG. 1) received from the print client 103 (FIG. 1) in the rendering request 163 (FIG. 1) into the form requested.

In this respect, the rendering broker 136 begins with box 303 in which it is determined whether a rendering request 163 has been received by the rendering broker 136. If such is the case, then the rendering broker 136 proceeds to box 306 in which the rendering request is parsed to identify the various rendering parameters included therein and to identify the non-rendered document 166 (FIG. 1) attached therewith.

Thereafter, in box 309 the rendering broker 136 determines the rendering operations that are to be performed to render the non-rendered document 166 into the rendered document 169 (FIG. 1). This is done by examining the non-rendered document 166 or by examining the associated rendering parameters to determine the specific rendering operations to be performed. Thereafter in box 313, the rendering broker 136 designates loop to perform each rendering operation to be performed and the rendering broker 136 designates a first one of the rendering operations to be performed in a loop that follows.

Thereafter in box 316, the rendering broker 136 identifies an appropriate rendering application to perform the current designated rendering operation and then obtains the specific requisition format requirements associated with the particular rendering application. Specifically, the rendering application may be located either on the rendering broker server 106 (FIG. 1) or on another device such as the rendering application server 109 coupled to the network 113 (FIG. 1). The name or other designation of the various rendering applications from which the rendering broker 136 may choose may be stored within a lookup table or database within the rendering broker 136. Such a lookup table or database may be consulted to determine the precise uniform resource locator or other location indicator of the particular rendering application 156 (FIG. 1) necessary to perform the desired rendering operation.

The requisition format requirements may also be stored in a database or lookup table and specifies a specific format of the rendering requisition 176 that is required by the rendering application 156 in order that it may perform the necessary rendering operations. Note that various data communication formats may be employed including, for example, Extensible Markup Language (XML) or some other language as is generally known by those with ordinary skill in the art. The rendering broker 136 then proceeds to box 319 in which a properly formatted rendering requisition 176 is generated in the memory 126 (FIG. 1) for the current rendering operation. Thereafter, in box 323 the document is included in the rendering requisition 176 as the unprocessed payload 179 (FIG. 1). Then, in box 326, the rendering broker 136 transmits the rendering requisition 176 to the rendering application 156 to perform the specific rendering operation.

In box 329, the rendering broker 136 waits to receive a rendering reply 186 (FIG. 1) from the rendering application 156. Assuming such is received, then the rendering broker 136 proceeds to box 333 in which it is determined whether the last rendering operation to be performed based upon the needs identified in the rendering request 163 has been completed. If not, then the rendering broker 136 moves to box 336 in which the next rendering operation to be performed is designated for processing. Thereafter, the rendering broker 136 reverts back to box 316.

On the other hand, assuming that the last rendering operation is performed as determined in box 333, then the rendering broker 136 proceeds to box 339 in which the broker response 173 is generated and the rendered document 169 (FIG. 1) is included therein. Then, in box 343 the broker response 173 is transmitted to the print client 103 so that the document may ultimately be printed. The rendering broker 136 then reverts back to box 303.

Although the rendering control system 219 and the rendering broker 136 of the present invention is embodied in software or code executed by general purpose hardware as discussed above, as an alternative the rendering control system 219 and the rendering broker 136 may also be embodied in dedicated hardware or a combination of software/general purpose hardware and dedicated hardware. If embodied in dedicated hardware, the rendering control system 219 and the rendering broker 136 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow charts of FIGS. 3 and 4 show the architecture, functionality, and operation of an implementation of the rendering control system 219 and the rendering broker 136. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flow charts of FIGS. 3 and 4 show a specific order of execution, it is understood that the order of execution may differ from that which is depicted. For example, the order of execution of two or more blocks may be scrambled relative to the order shown. Also, two or more blocks shown in succession in FIGS. 3 and 4 may be executed concurrently or with partial concurrence. In addition, any number of counters, state variables, warning semaphores, or messages might be added to the logical flow described herein, for purposes of enhanced usability, accounting, performance measurement, or providing troubleshooting aids, etc. It is understood that all such variations are within the scope of the present invention. Also, the flow charts of FIGS. 3 and 4 are relatively self-explanatory and are understood by those with ordinary skill in the art to the extent that software and/or hardware can be created by one with ordinary skill in the art to carry out the various logical functions as described herein.

Also, where rendering control system 219 and the rendering broker 136 comprise software or code, both can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain rendering control system 219 and the rendering broker 136 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain preferred embodiments, it is obvious that equivalents and modifications will occur to others skilled in the art upon the reading and understanding of the specification. The present invention includes all such equivalents and modifications, and is limited only by the scope of the claims.

What is claimed is:

1. A method for brokered rendering, comprising:
examining a document embodied in a non-rendered format in a computer system to identify at least one rendering operation to be performed to convert the document into a rendered format to be employed in printing the document;
identifying at least one rendering application capable of performing the at least one rendering operation; and
applying the document to the at least one rendering application to implement the at least one rendering operation.

2. The method of claim 1, wherein the step of examining the document embodied in the non-rendered format in the computer system to identify the at least one rendering operation to be performed to convert the document into the rendered format to be employed in printing the document further comprises identifying a predefined rendering operation to be performed that converts the document embodied in the non-rendered format into an intermediate print format, wherein the rendered format is the intermediate print format.

3. The method of claim 1, wherein the step of examining the document embodied in the non-rendered format in the computer system to identify the at least one rendering operation to be performed to convert the document into the rendered format to be employed in printing the document further comprises identifying a predefined rendering operation to be performed that converts the document embodied in an intermediate print format into a printer ready format, wherein the non-rendered format is the intermediate print format and the rendered format is the printer ready format.

4. The method of claim 2, wherein the step of identifying the at least one rendering application capable of performing the at least one rendering operation further comprises identifying a predefined rendering application that converts the document embodied in the non-rendered format into the intermediate print format.

5. The method of claim 3, wherein the step of identifying the at least one rendering application capable of performing the at least one rendering operation further comprises identifying a driver that converts the intermediate print format of the document into the printer ready format.

6. The method of claim 1, wherein the step of examining the document embodied in the non-rendered format in the computer system to identify the at least one rendering operation to be performed to convert the document into the rendered format to be employed in printing the document further comprises identifying an application used to generate the document embodied in the non-rendered format.

7. The method of claim 1, wherein the step of applying the document to the at least one rendering application to implement the at least one rendering operation further comprises:
generating a rendering requisition formatted according to a formatting requirement of the at least one rendering application;
associating the document embodied in the non-rendered format with the rendering requisition; and
applying the rendering requisition to the at least one rendering application.

8. The method of claim 1, wherein the step of applying the document to the at least one rendering application to implement the at least one rendering operation further comprises transmitting the document across a network to the at least one rendering application.

9. The method of claim 1, further comprising storing a rendering request that includes the document embodied in the non-rendered format in a memory, the rendering request being received from a remote device and requesting a conversion of the document embodied in the non-rendered format into the rendered format.

10. The method of claim 1, further comprising:
receiving the document in the rendered format from the at least one rendering application; and
transmitting the document in the rendered format to a remote application across a network for printing.

11. A system for brokered rendering, comprising:
a processor circuit having a processor and a memory;
a rendering broker stored in the memory and executable by the processor, the rendering broker comprising:
logic that examines a document embodied in a non-rendered format to identify at least one rendering operation to be performed to convert the document into a rendered format to be employed in printing the document;
logic that identifies at least one rendering application capable of performing the at least one rendering operation; and
logic that applies the document to the at least one rendering application to implement the at least one rendering operation.

12. The system of claim 11, wherein the logic that examines the document embodied in the non-rendered format to identify the at least one rendering operation to be performed to convert the document into the rendered format to be employed in printing the document further comprises logic that identifies a predefined rendering operation to be performed that converts the document embodied in the non-rendered format into an intermediate print format, wherein the rendered format is the intermediate print format.

13. The system of claim 11, wherein the logic that examines the document embodied in the non-rendered format to identify the at least one rendering operation to be performed to convert the document into the rendered format to be employed in printing the document further comprises logic that identifies a predefined rendering operation to be performed that converts the document embodied in an intermediate print format into a printer ready format, wherein the non-rendered format is the intermediate print format and the rendered format is the printer ready format.

14. The system of claim 12, wherein the logic that identifies at least one rendering application capable of performing the at least one rendering operation further comprises logic that identifies a predefined rendering application that converts the document embodied in the non-rendered format into the intermediate print format.

15. The system of claim 13, wherein the logic that identifies the at least one rendering application capable of performing the at least one rendering operation further comprises logic that identifies a driver that converts the intermediate print format of the document into the printer ready format.

16. The system of claim 11, wherein the logic that examines the document embodied in the non-rendered format to identify the at least one rendering operation to be performed to convert the document into the rendered format to be employed in printing the document further comprises logic that identifies an application used to generate the document embodied in the non-rendered format.

17. The system of claim 11, wherein the logic that applies the document to the at least one rendering application to implement the at least one rendering operation further comprises:
logic that generates a rendering requisition formatted according to a formatting requirement of the at least one rendering application;
logic that associates the document with the rendering requisition; and
logic that applies the rendering requisition to the at least one rendering application.

18. A program embodied in a computer readable medium for brokered rendering, comprising:
code that examines a document embodied in a non-rendered format to identify at least one rendering operation to be performed to convert the document into a rendered format to be employed in printing the document;
code that identifies at least one rendering application capable of performing the at least one rendering operation; and
code that applies the document to the at least one rendering application to implement the at least one rendering operation.

19. The program embodied in a computer readable medium of claim 18, wherein the code that examines the document embodied in the non-rendered format to identify the at least one rendering operation to be performed to convert the document into the rendered format to be employed in printing the document further comprises code that identifies a predefined rendering operation to be performed that converts the document embodied in the non-rendered format into an intermediate print format, wherein the rendered format is the intermediate print format.

20. The program embodied in a computer readable medium of claim 18, wherein the code that examines the document embodied in the non-rendered format to identify the at least one rendering operation to be performed to convert the document into the rendered format to be employed in printing the document further comprises code that identifies a predefined rendering operation to be performed that converts the document embodied in an intermediate print format into a printer ready format, wherein the non-rendered format is the intermediate print format and the rendered format is the printer ready format.

21. The program embodied in a computer readable medium of claim 19, wherein the code that identifies at least one rendering application capable of performing the at least one rendering operation further comprises code that identifies a predefined rendering application that converts the document embodied in the non-rendered format into the intermediate print format.

22. The program embodied in a computer readable medium of claim 20, wherein the code that identifies the at least one rendering application capable of performing the at least one rendering operation further comprises code that identifies a driver that converts the intermediate print format of the document into the printer ready format.

23. The program embodied in a computer readable medium of claim 18, wherein the code that examines the document embodied in the non-rendered format to identify the at least one rendering operation to be performed to convert the document into the rendered format to be employed in printing the document further comprises code that identifies an application used to generate the document embodied in the non-rendered format.

24. The program embodied in a computer readable medium of claim 18, wherein the code that applies the document to the at least one rendering application to implement the at least one rendering operation further comprises:
code that generates a rendering requisition formatted according to a formatting requirement of the at least one rendering application;
code that associates the document with the rendering requisition; and
code that applies the rendering requisition to the at least one rendering application.

25. A system for brokered rendering, comprising:
means for examining a document embodied in a non-rendered format to identify at least one rendering operation to be performed to convert the document into a rendered format to be employed in printing the document;
means for identifying at least one rendering application capable of performing the at least one rendering operation; and
means for applying the document to the at least one rendering application to implement the at least one rendering operation.

26. The system of claim 25, wherein the means for examining the document embodied in the non-rendered format to identify the at least one rendering operation to be performed to convert the document into the rendered format to be employed in printing the document further comprises means for identifying a predefined rendering operation to be performed that converts the document embodied in the non-rendered format into an intermediate print format, wherein the rendered format is the intermediate print format.

27. The system of claim 25, wherein the means for examining the document embodied in the non-rendered format to identify the at least one rendering operation to be performed to convert the document into the rendered format to be employed in printing the document further comprises means for identifying a predefined rendering operation to be performed that converts the document embodied in an intermediate print format into a printer ready format, wherein the non-rendered format is the intermediate print format and the rendered format is the printer ready format.

28. The system of claim 26, wherein the means for identifying at least one rendering application capable of performing the at least one rendering operation further comprises means for identifying a predefined rendering application that converts the document embodied in the non-rendered format into the intermediate print format.

29. The system of claim 27, wherein the means for identifying the at least one rendering application capable of performing the at least one rendering operation further comprises means for identifying a driver that converts the intermediate print format of the document into the printer ready format.
